(19) United States
(12) Patent Application Publication
(10) Pub. No.: US 2024/0118979 A1
(43) Pub. Date: Apr. 11, 2024

(54) Cloud-Based Recovery of Snapshot Images Between Heterogeneous Storage Arrays

(71) Applicant: Dell Products, L.P., Hopkinton, MA (US)

(72) Inventors: Kenneth Byrne, Knockraha (IE); Santhosh Krishnegowda, Bangalore (IN); Shane Sullivan, Franklin, MA (US); Mark Aldred, Franklin, MA (US); Deepak Vokaliga, Hopkinton, MA (US)

(21) Appl. No.: 17/962,472

(22) Filed: Oct. 8, 2022

(51) Int. Cl. G06F 11/14

(52) U.S. Cl. CPC G06F 11/1469; G06F 11/1464; G06F 2201/84

(57) ABSTRACT

Cloud metadata is generated by a cloud block management system on a first storage array. The cloud metadata includes information identifying one or more cloud providers, one or more cloud repositories created on the cloud providers, and block objects stored in the cloud repositories. A metadata backup file containing a copy of the cloud metadata is generated, encrypted, and exported to an external computer. A second cloud block management system is created on a second storage array, and the metadata backup file containing the copy of the cloud metadata is decrypted and imported to the second cloud block management system. The cloud metadata from the metadata backup file is used to configure the second cloud block management system to access the one or more cloud providers, access the one or more cloud repositories created on the cloud providers, and to access the block objects stored in the cloud repositories.

### FIELD

This disclosure relates to computing systems and related devices and methods, and, more particularly, to a cloud-based recovery of snapshot images between heterogeneous storage arrays.

### SUMMARY

The following Summary and the Abstract set forth at the end of this document are provided herein to introduce some concepts discussed in the Detailed Description below. The Summary and Abstract sections are not comprehensive and are not intended to delineate the scope of protectable subject matter, which is set forth by the claims presented below.

All examples and features mentioned below can be combined in any technically possible way.

Storage arrays provide storage resources and are used to store storage volumes. For redundancy, similar storage arrays can be configured to implement a remote data forwarding facility, on which data written to one of the storage arrays is automatically mirrored to the other storage array. Similarly, point in time copies of the storage volume can be created on one of the storage arrays and added to the remote data forwarding facility to be mirrored to the other storage array. Establishing a remote data forwarding facility enables an application image to be established on the second storage array, so that the application can fail over to the second storage array in the event of a failure of the first storage array. Unfortunately, in instances where the storage arrays are heterogeneous, it might not be possible to configure a remote data facility between the storage arrays. This can make it difficult to restore an application image from a first storage array to a second storage array.

According to some embodiments, a containerized cloud application referred to herein as a “cloud block management system” is instantiated on a first storage array and used to store snapshot images of a set of application storage volumes in a cloud repository. The cloud block management system creates metadata describing the set of cloud providers, the cloud repositories on the cloud providers, and the set storage objects resident in the cloud repositories.

To migrate the application image to a second, heterogeneous storage array, a metadata file containing the cloud metadata from the cloud block management system is exported from the first storage system to a host computer such as a laptop computer. An instance of the cloud block management system is started on the second, heterogeneous storage array, the host computer is connected to the second storage array, and the metadata file is imported to the instance of the cloud block management system on the second storage array. The cloud block management system executing in the second storage array uses the metadata from the imported file to configure the cloud block management system on the second storage array so that the cloud block management system is both capable of cloud access and connected to the same cloud repository as the original system. Once the new instance of the cloud block management system on the second storage system has been configured and connected to the cloud repository, the snapshots of the storage volume can be viewed or downloaded to the second heterogeneous storage system to thus recover the application image to the second, heterogeneous, storage system.

### BRIEF DESCRIPTION OF THE DRAWINGS

FIG. 1 is a functional block diagram of an example storage system connected to a host computer, according to some embodiments.

FIG. 2 is a functional block diagram of an example storage environment including two storage systems, one of which is configured to store an application image in one or more cloud repositories provided by one or more cloud providers, according to some embodiments.

FIG. 3 is a functional block diagram of an example storage environment showing a process of implementing cloud-based recovery of snapshot images between heterogeneous storage arrays, according to some embodiments.

FIG. 4 is a flow chart of an example process of cloud-based recovery of snapshot images between heterogeneous storage arrays, according to some embodiments.

FIG. 5 is a functional block diagram of an example storage system in greater detail, and including several components configured to enable cloud-based recovery of snapshot images between heterogeneous storage arrays, according to some embodiments.

FIG. 6 is a functional block diagram of an example data structure configured to contain cloud metadata, according to some embodiments.

### DETAILED DESCRIPTION

Aspects of the inventive concepts will be described as being implemented in a storage system 100 connected to a host computer 102. Such implementations should not be viewed as limiting. Those of ordinary skill in the art will recognize that there are a wide variety of implementations of the inventive concepts in view of the teachings of the present disclosure.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g., and without limitation, abstractions of tangible features. The term “physical” is used to refer to tangible features, including but not limited to electronic hardware. For example, multiple virtual computing devices could operate simultaneously on one physical computing device. The term “logic” is used to refer to special purpose physical circuit elements, firmware, and/or software implemented by computer instructions that are stored on a non-transitory tangible computer-readable medium and implemented by multi-purpose tangible processors, and any combinations thereof.

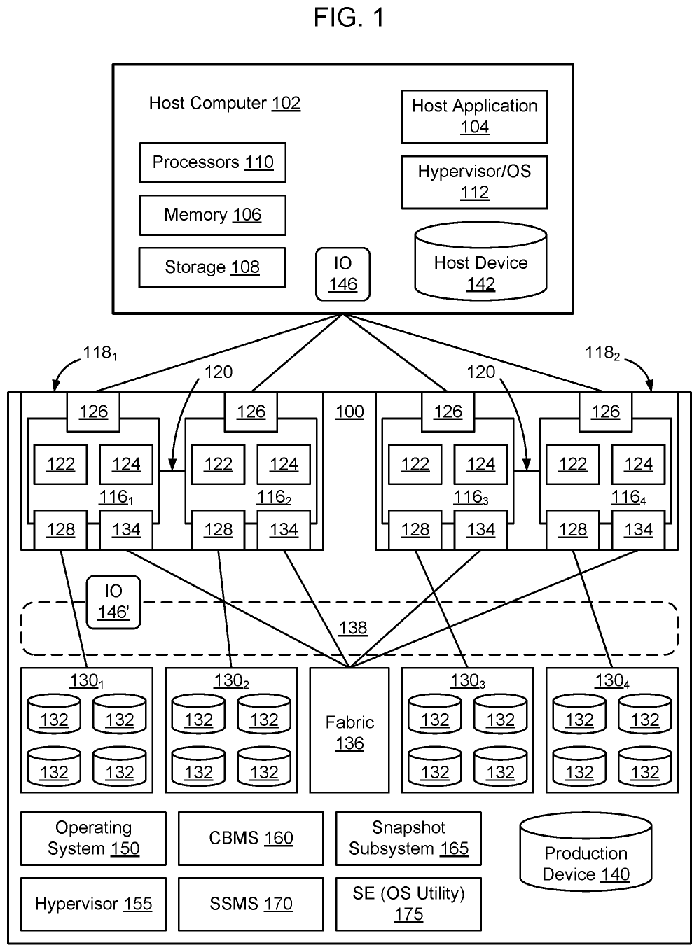

FIG. 1 illustrates a storage system 100 and an associated host computer 102, of which there may be many. The storage system 100 provides data storage services for a host application 104, of which there may be more than one instance and type running on the host computer 102. In the illustrated example, the host computer 102 is a server with host volatile memory 106, persistent storage 108, one or more tangible processors 110, and a hypervisor and OS (Operating System) 112. The processors 110 may include one or more multi-core processors that include multiple CPUs (Central Processing Units), GPUs (Graphics Processing Units), and combinations thereof. The host volatile memory 106 may include RAM (Random Access Memory) of any type. The persistent storage 108 may include tangible persistent storage components of one or more technology types, for example and without limitation SSDs (Solid State Drives) and HDDs (Hard Disk Drives) of any type, including but not limited to SCM (Storage Class Memory), EFDs (Enterprise Flash Drives), SATA (Serial Advanced Technology Attachment) drives, and FC (Fibre Channel) drives. The host computer 102 might support multiple virtual hosts running on virtual machines or containers. Although an external host computer 102 is illustrated in FIG. 1, in some embodiments host computer 102 may be implemented as a virtual machine within storage system 100.

The storage system 100 includes a plurality of compute nodes 116₁-116₄, possibly including but not limited to storage servers and specially designed compute engines or storage directors for providing data storage services. In some embodiments, pairs of the compute nodes, e.g. (116₁-116₂) and (116₃-116₄), are organized as storage engines 118₁ and 118₂, respectively, for purposes of facilitating failover between compute nodes 116 within storage system 100. In some embodiments, the paired compute nodes 116 of each storage engine 118 are directly interconnected by communication links 120. As used herein, the term “storage engine” will refer to a storage engine, such as storage engines 118₁ and 118₂, which has a pair of (two independent) compute nodes, e.g. (116₁-116₂) or (116₃-116₄). A given storage engine 118 is implemented using a single physical enclosure and provides a logical separation between itself and other storage engines 118 of the storage system 100. A given storage system 100 may include one storage engine 118 or multiple storage engines 118.

Each compute node, 116₁, 116₂, 116₃, 116₄, includes processors 122 and a local volatile memory 124. The processors 122 may include a plurality of multi-core processors of one or more types, e.g., including multiple CPUs, GPUs, and combinations thereof. The local volatile memory 124 may include, for example and without limitation, any type of RAM. Each compute node 116 may also include one or more front-end adapters 126 for communicating with the host computer 102. Each compute node 116₁-116₄ may also include one or more back-end adapters 128 for communicating with respective associated back-end drive arrays 130₁-130₄, thereby enabling access to managed drives 132. A given storage system 100 may include one back-end drive array 130 or multiple back-end drive arrays 130.

In some embodiments, managed drives 132 are storage resources dedicated to providing data storage to storage system 100 or are shared between a set of storage systems 100. Managed drives 132 may be implemented using numerous types of memory technologies for example and without limitation any of the SSDs and HDDs mentioned above. In some embodiments the managed drives 132 are implemented using NVM (Non-Volatile Memory) media technologies, such as NAND-based flash, or higher-performing SCM (Storage Class Memory) media technologies such as 3D XPoint and ReRAM (Resistive RAM). Managed drives 132 may be directly connected to the compute nodes 116₁-116₄, using a PCIe (Peripheral Component Interconnect Express) bus or may be connected to the compute nodes 116₁-116₄, for example, by an IB (InfiniBand) bus or fabric.

In some embodiments, each compute node 116 also includes one or more channel adapters 134 for communicating with other compute nodes 116 directly or via an interconnecting fabric 136. An example interconnecting fabric 136 may be implemented using InfiniBand. Each compute node 116 may allocate a portion or partition of its respective local volatile memory 124 to a virtual shared “global” memory 138 that can be accessed by other compute nodes 116, e.g., via DMA (Direct Memory Access) or RDMA (Remote Direct Memory Access). Shared global memory 138 will also be referred to herein as the cache of the storage system 100.

The storage system 100 maintains data for the host applications 104 running on the host computer 102. For example, host application 104 may write data of host application 104 to the storage system 100 and read data of host application 104 from the storage system 100 in order to perform various functions. Examples of host applications 104 may include but are not limited to file servers, email servers, block servers, and databases.

Logical storage devices are created and presented to the host application 104 for storage of the host application 104 data. For example, as shown in FIG. 1, a production device 140 and a corresponding host device 142 are created to enable the storage system 100 to provide storage services to the host application 104.

The host device 142 is a local (to host computer 102) representation of the production device 140. Multiple host devices 142, associated with different host computers 102, may be local representations of the same production device 140. The host device 142 and the production device 140 are abstraction layers between the managed drives 132 and the host application 104. From the perspective of the host application 104, the host device 142 is a single data storage device having a set of contiguous fixed-size LBAs (Logical Block Addresses) on which data used by the host application 104 resides and can be stored. However, the data used by the host application 104 and the storage resources available for use by the host application 104 may actually be maintained by the compute nodes 116₁-116₄ at non-contiguous addresses (tracks) on various different managed drives 132 on storage system 100.

In some embodiments, the storage system 100 maintains metadata that indicates, among various things, mappings between the production device 140 and the locations of extents of host application data in the virtual shared global memory 138 and the managed drives 132. In response to an IO (Input/Output command) 146 from the host application 104 to the host device 142, the hypervisor/OS 112 determines whether the IO 146 can be serviced by accessing the host volatile memory 106. If that is not possible then the IO 146 is sent to one of the compute nodes 116 to be serviced by the storage system 100.

In the case where IO 146 is a read command, the storage system 100 uses metadata to locate the commanded data, e.g., in the virtual shared global memory 138 or on managed drives 132. If the commanded data is not in the virtual shared global memory 138, then the data is temporarily copied into the virtual shared global memory 138 from the managed drives 132 and sent to the host application 104 by the front-end adapter 126 of one of the compute nodes 116₁-116₄. In the case where the IO 146 is a write command, in some embodiments the storage system 100 copies a block being written into the virtual shared global memory 138, marks the data as dirty, and creates new metadata that maps the address of the data on the production device 140 to a location to which the block is written on the managed drives 132.

As shown in FIG. 1, in some embodiments the storage system 100 has an operating system 150, and a hypervisor 155. In some embodiments, operating system 150 is an embedded operating system of the storage system 100. An example operating system 150 may be based on Linux, although other operating systems may also be used. Hypervisor 155 is used to abstract the physical resources of the storage system, to enable at least some of the system applications to execute in emulations (e.g., virtual machines) on the storage system. Example system applications shown in FIG. 1 include a snapshot subsystem, a cloud block management system 160, a snapshot subsystem 165, and a storage system management application 170. Each of these components is described in greater detail below.

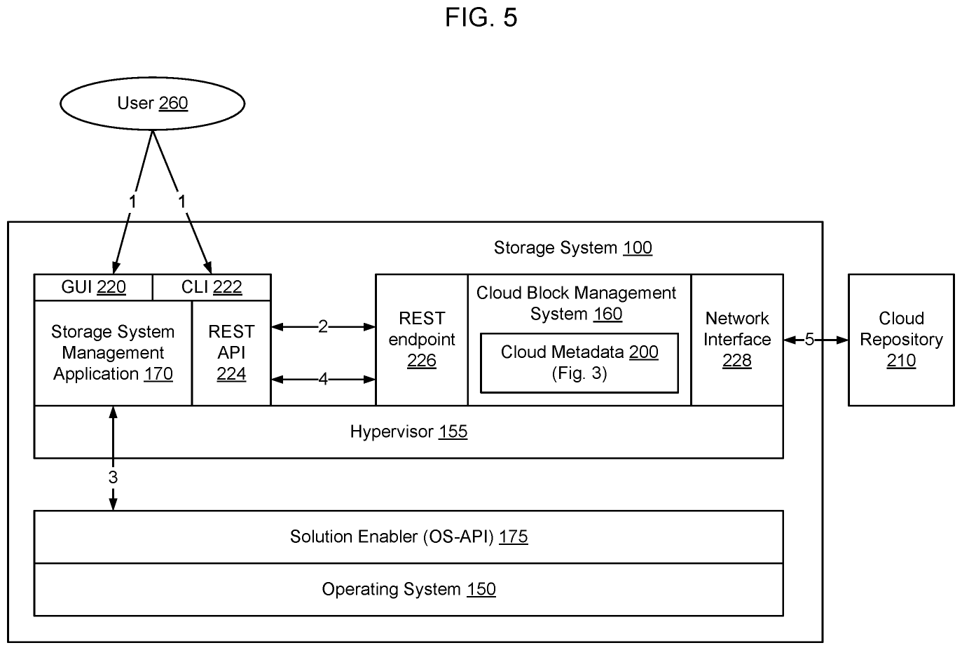

The storage system management application 170, in some embodiments, is an application executing in a container in the storage system 100. An example storage system management application is Unisphere™ although many other storage system management applications exist and can be used depending on the implementation. As shown in FIG. 5, in some embodiments a user 260 interacts with the storage system management application 170 via a GUI (Graphical User Interface) 220 or through a command line interface 222, and uses the storage system management application 170 to configure operation of the storage system 100. In some embodiments, the storage system management application 170 includes control logic configured to orchestrate the process of setting up a containerized cloud communication system implemented by cloud block management system 160 in the embedded operating system 150, to automatically configure the requisite components of the storage system 100 to enable access to cloud repository 210.

In some embodiments, the storage system 100 includes an operating system utility, referred to herein as a solution enabler 175, that is configured to interact with the operating system to adjust operation of the storage system. Solution enabler 175, in some embodiments, acts as a middle layer between operating system 150 and the storage system management application 170 to enable the storage system management application 170 to create environments on the storage system 100, create storage groups, and perform multiple other operations. In some embodiments, the solution enabler 175 provides an API layer to the operating system 150, and accordingly is also referred to herein as an OS-API (Operating System Application Programing Interface).

The Cloud Block Management System (CBMS) 160 is responsible for managing transmission of snapshots and other volumes of data from the storage system 100 to the cloud repository 210 over network interfaces 228. For example, it may be desirable to maintain a complete lineage of application snapshots, to enable the lineage of application snapshots to be used to recover an application image back to the storage system 100 in event of a failure. In some embodiments, if access to the cloud repository 210 is desired, the storage system management application 170 causes an instance of cloud block management system 160 to be created on the storage system 100, and then orchestrates interconnecting the cloud block management system 160 with the cloud repository 210. In some embodiments, the cloud block management system 160 is implemented as an application executing in a container in an emulation on storage system 100. A given storage system may have multiple instances of cloud block management system 160 instantiated thereon at any given point in time.

For example, if a user decides to start to move volumes of data from the storage system 100 to the cloud repository 210, an instance of the cloud block management system 160 will need to be instantiated in an emulation of the storage system 100. Once created, the cloud block management system 160 will need to be linked to the storage system management application 170. The cloud block management system 160 will also need to be configured on the storage system 100, the required cloud protection environment in the storage system operating system will need to be created, network interfaces 228 will need to be created on the cloud block management system 160, and connections between the cloud block management system 160 and the cloud provider will need to be established.

As shown in FIG. 5, in some embodiments the storage system management application 170 has a Representational State Transfer (REST) Application Programming Interface (API) 224 that it uses to communicate with public REST and private REST endpoints 226 on the cloud block management system 160. Other ways of communicating between the storage system management application 156 and cloud block management system 160 may be implemented as well. In some embodiments, the REST endpoints 224, 226 are used to obtain access to a metadata backup file 250 containing cloud metadata 220 from an instance of a cloud block management system 160 on a first storage system, and to enable the metadata backup file 250 to be provided to a second instance of cloud block management system on a second storage system.

The cloud block management system 160, in some embodiments, may be used to move snapshots of filesystems to cloud repository 210. Snapshot subsystem 165, in some embodiments, is configured to create these “snapshots”. A “snapshot,” as that term is used herein, is a copy of a volume of data as that volume existed at a particular point in time. A snapshot of a production device 140, accordingly, is a copy of the data stored on the production device 140 as the data existed at the point in time when the snapshot was created. A snapshot can be either target-less (not linked to a TDev) or may be linked to a target Thin Device (TDev) when created. When a snapshot of a production volume is created, the snapshot may include all of the data of the production volume, or only the changes to the production volume that have occurred since the previous snapshot was taken.

In some embodiments, a user 260 will set policies on a group of LUNs referred to as a storage group. These policies define the frequency of the snapshots, the retention period of the snapshots, and optionally a cloud provider where the snapshots are to be stored. The frequency tells the snapshot subsystem 165 in the storage array 130 to create a snapshot against all the LUNs in a storage group at a regular cadence, as defined by the user 260. The sets of snapshots taken against a storage group are referred to as snapsets. The retention period defines the age of the snapshot when it should be deleted. If a cloud provider is specified, this parameter tells the storage array the identity of the cloud-based object repository 210 where the snapshots need to be shipped.

Using a cloud block management system 160 provides a remote protection solution, where the LUN based snapshots of an application stored on the storage system can be migrated to any heterogeneous cloud repository, thus creating an application image that can be recovered to the original storage system at any time. However, if the user would like to recover the application image to a different storage system, recovery from the cloud repository is not straightforward.

According to some embodiments, a solution is provided that enables cloud configuration metadata 200, that is created by the cloud block management system 160 on the original storage system, to be downloaded and ported to a second storage system.

In some embodiments, the cloud block management system 160, on the original storage system, is configured to periodically backup the cloud configuration metadata 200 and store the cloud configuration metadata in a backup file. To enable access to the application image on a second storage system, in some embodiments a user accesses the metadata backup file 250 containing the cloud configuration metadata 200, for example via the storage system management application 170, and downloads a copy of the metadata backup file 250 containing the cloud configuration metadata 200. If the metadata backup file 250 containing the cloud configuration metadata 200 is downloaded to a system outside of the storage system 100, in some embodiments the file containing the cloud configuration metadata 200 is encrypted. In some embodiments the user is prompted to provide a password that is used in connection with encrypting the copy of the metadata backup file 250.

Once the metadata backup file 250 containing the cloud configuration metadata 200 is downloaded to be manually ported to a different heterogeneous storage system, the user accesses the user interface of a storage system management application 170 on the second storage system, and uses the GUI 220 or CLI 222 on the second storage system to instruct the storage system management application 170 on the second storage system to create a new instance of a cloud block management system 160 on the second storage system. Using the storage system management application 170 on the second storage system, the user configures the cloud settings so that the new system is both cloud capable and connected to the same repository as the original system.

According to some embodiments, using the storage system management application on the second storage system, the user uploads the metadata backup file 250 containing the cloud configuration metadata 200, that was downloaded from the first storage system, to the new instance of the cloud block management system 160 on the second storage system. In embodiments where the metadata backup file 250 containing the cloud configuration metadata 200 was encrypted, the user will be prompted to supply the password to enable the metadata backup file 250 to be decrypted. Upon receipt of the metadata backup file 250 containing the cloud configuration metadata 200, the new instance of the cloud block management system 160 will re-initialize the cloud metadata from the original system into its databases. Since the new instance of the cloud block management system 160 does not have any previous metadata, initializing the cloud metadata from the original instance into the databases does not require integration/conflict resolution.

In some embodiments, the storage system management application synchronizes the details contained in the metadata backup file 250 containing the cloud configuration metadata 200 with the new instance of the cloud block management system 160. For example, in some embodiments the storage system management application uses the metadata contained in the metadata backup file 250 containing the cloud configuration metadata 200 to create a new set of cloud providers on the second storage system, remove any old providers on the second storage system, ensure that the cloud environment is setup on the second storage system, and that the environment is communicating correctly with the new shared cloud repository.

Once established, the new instance of the cloud block management system 160 on the second storage system is able to view/delete or recover the complete application image to the second storage system. Specifically, the cloud block management system 160 can use existing mechanisms to recover an application image to the second storage system, thus enabling the application image to be recovered to the second storage system. By enabling recovery to the second storage system, without requiring the first and second storage systems to have a mirroring relationship, it is possible to transfer application images between heterogeneous storage systems that otherwise would not be capable of being configured to participate in a remote data forwarding (mirroring) relationship.

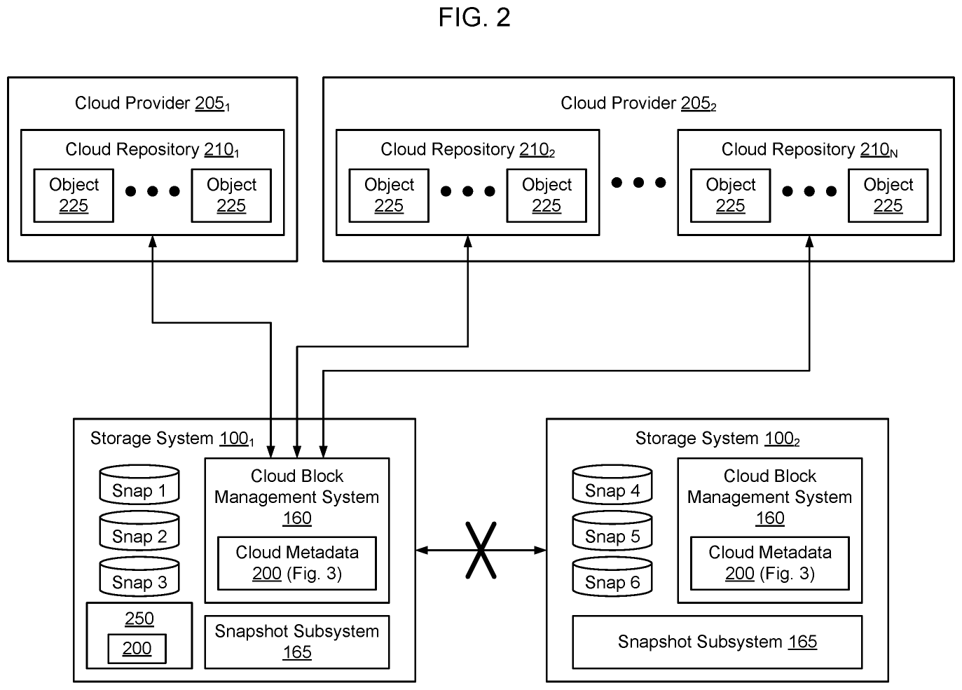

FIG. 2 is a functional block diagram of an example storage environment including two storage systems, one of which is configured to store an application image in a cloud provider, according to some embodiments. As shown in FIG. 2, in some instances heterogeneous storage systems are not able to be configured in a mirroring relationship. Specifically, in FIG. 2, storage system 100₁ and storage system 100₂ are differently configured (heterogeneous) and accordingly it is not possible to configure a remote data forwarding relationship between the two storage systems. However, it might be desirable to enable an application image created on storage system 100₁ to be migrated to storage system 100₂. According to some embodiments, in instances where storage system 100₁ is connected to one or more cloud repositories 210₁-210_{N} provided by one or more cloud providers 205₁, 205₂, a process of implementing cloud-based recovery of snapshot images between heterogeneous storage arrays is able to be used to recreate a complete application image on the second storage system 100₂.

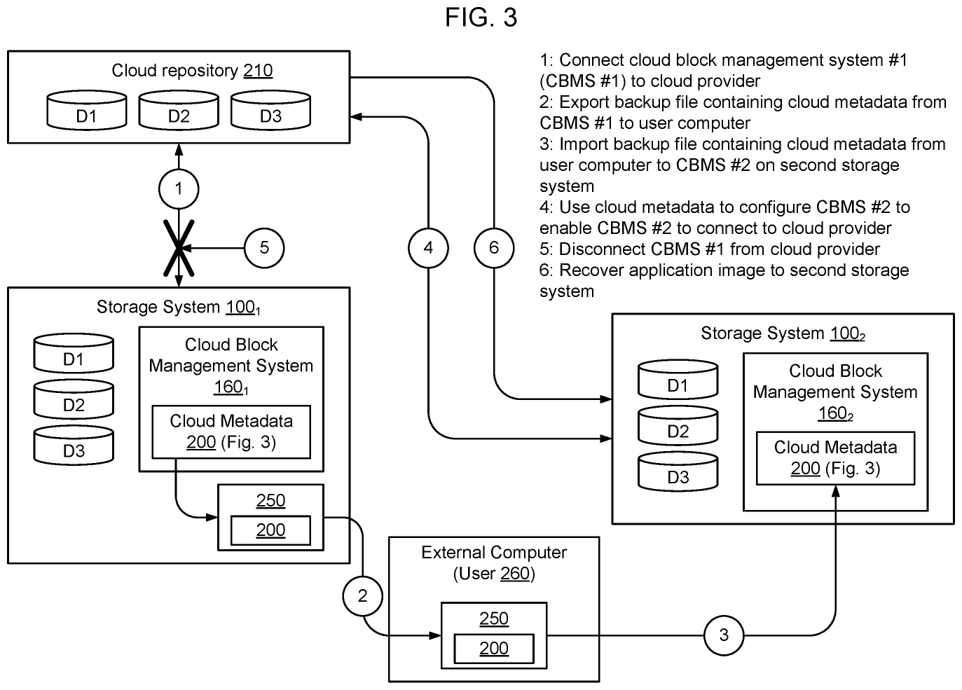

FIG. 3 is a functional block diagram of an example storage environment showing a process of implementing cloud-based recovery of snapshot images between heterogeneous storage arrays, according to some embodiments. As shown in FIG. 3, in some embodiments a cloud block management system 160₁ on a first storage system 100₁ is connected to a cloud provider 200. Snapshots of an application image (volumes D1, D2, and D3 in FIG. 3) are uploaded by cloud block management system 160₁ to the cloud provider 200 (arrow 1). In normal operation, if the application image needs to be restored on storage system 100₁, the cloud block management system 160₁ on storage system 100₁ can import the one or more snapshots to enable the application image to be recovered on storage system 100₁.

The cloud block management system 160₁ creates cloud metadata 200 that describes the set of cloud providers 205, the set of cloud repositories 210 created on the cloud providers 205, the objects 225 that have been stored in the cloud repositories 210, and other information required to access the objects 225 that are stored in the cloud repositories 210. The cloud metadata 200 is periodically backed up and stored in a metadata backup file 250.

To enable cloud-based recovery of snapshot images between heterogeneous storage arrays, according to some embodiments, the metadata backup file 250 containing the cloud configuration metadata 200 is exported from the cloud block management system 160₁ to an external computer (arrow 2). For example, the metadata backup file 250 may be exported to a user's laptop computer, may be stored on a thumb drive, or may otherwise be transmitted outside of the storage system 100₁. In instances where the storage system management application 170 on storage system 100₁ is able to be accessed by a user from a remote location, the metadata backup file 250 may be accessed by the user via the storage system management application 170 and exported to the user at the remote location via the communication channel between the user and the storage system management application. In some embodiments, to protect the integrity of the cloud metadata contained in the metadata backup file 250, and to ensure security of the cloud metadata 200 and prevent unauthorized access to the cloud repositories 210, the metadata backup file 250 is encrypted with a password in connection with exporting the metadata backup file 250 containing the cloud metadata 200.

A new instance of a cloud block management system 160₂ is started on the storage system 100₂ where the application image is to be created. Once the cloud block management system 160₂ has been started, and the storage system 100₂ is otherwise configured for cloud access, the metadata backup file 250 containing the cloud metadata 200 is imported from the external computer to the cloud block management system 160₂ on the second storage system 100₂ (arrow 3). The cloud block management system 160₂ uses the cloud metadata 200 to configure the cloud block management system 160₂ on the second storage system 100₂ to connect to the cloud repositories 210 that were previously used by the first storage system 100₁ (arrow 4). Optionally, the first storage system 100₁ can then be disconnected from the cloud repositories (arrow 5). Once the second storage system 100₂ is connected to the cloud repositories 210 that were previously used by the first storage system 100₁, the cloud block management system 160₂ on the second storage system 100₂ is able to recover the application image to the second storage system (arrow 6). In this manner, it is possible to implement cloud-based recovery of snapshot images between heterogeneous storage arrays.

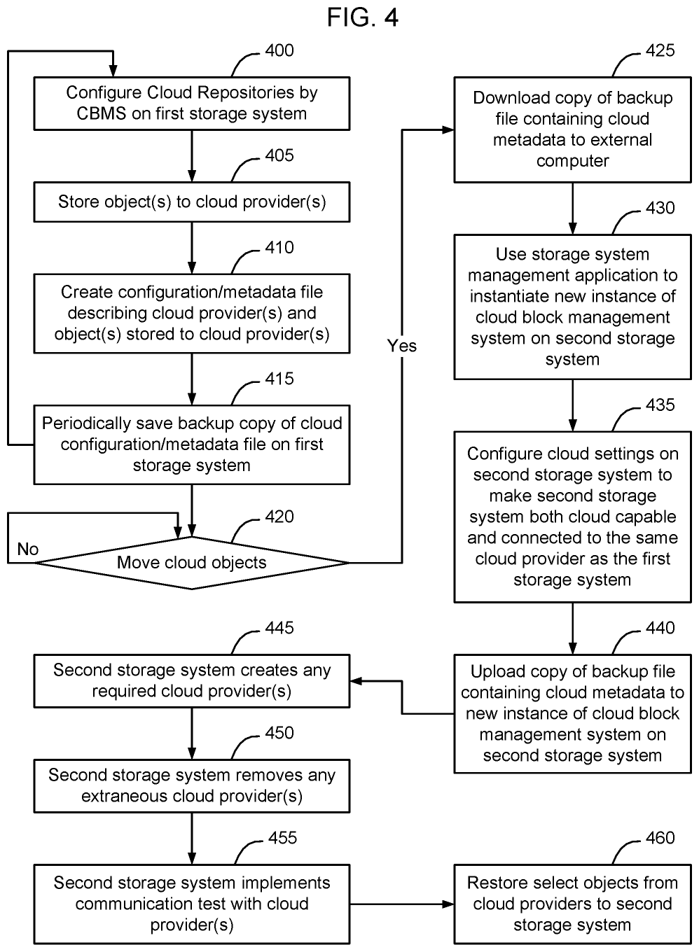

FIG. 4 is a flow chart of an example process of cloud-based recovery of snapshot images between heterogeneous storage arrays, according to some embodiments. As shown in FIG. 4, in some embodiments a cloud repository is configured by a cloud block management system 160₁ on a first storage system 100₁ (block 400). The cloud block management system 160₁ on a first storage system 100₁ stores objects to the cloud repository (block 405). Creating the cloud repositories and storing objects to the cloud repository results in creation of cloud metadata on the cloud block management system 160₁ (Block 410). For example, the cloud metadata can be stored in a metadata backup file 250 that describes the cloud provider(s), the cloud repositories on the cloud provider(s), and the object(s) stored to the cloud repositories. Many types of metadata may be created by the cloud block management system 160 depending on the implementation. In some embodiments, a backup copy of the cloud metadata is created periodically (block 415), for example every 30 minutes or every time the cloud metadata changes, to enable the cloud block management system to be restored in the event of a failure of the cloud block management system.

The process (blocks 400-415) is implemented by the cloud block management system while the cloud block management system 160₁ on the first storage system is responsible for the objects in the cloud repository (a determination of NO at block 420).

If a determination is made to move one or more of the cloud objects to a second storage system (a determination of YES at block 420), a copy of the metadata backup file 250 containing the cloud metadata is exported to an external computer (block 425). A storage system management application is used to instantiate a new instance of the cloud block management system 160₂ on the second storage system 100₂ where the objects are to be used (block 430). Cloud settings on the second storage system 100₂ are then configured to make the second storage system both cloud capable, and connected to the same cloud provider 205 as the first storage system (block 435).

The metadata backup file 250 containing the cloud metadata 200 is uploaded to the new instance of the cloud block management system on the second storage system (block 440). For example, as shown in FIG. 5, the metadata backup file 250 may be exported by the user 260 to the storage system management application 170 (arrow 1), and then provided by the storage system management application 170 to the cloud block management system 160 over the REST API 224/Rest endpoint 226 (arrow 2). The second storage system configures any data structures via interaction with solutions enabler (arrows 3 and 4) and interfaces 228 required to interact (arrow 5) with the cloud providers (block 445), removes any extraneous cloud providers from the data structures (block 450), and in some embodiments implements a communication test with the cloud providers (block 455). Once the cloud block storage system 160₂ has been configured using the metadata backup file 250 of the cloud metadata 200 on the second storage system 100₂, it is possible to restore select objects from the cloud repositories to the second storage system 100₂ (block 460), thus enabling a complete application image to be created at the second storage system 100₂.

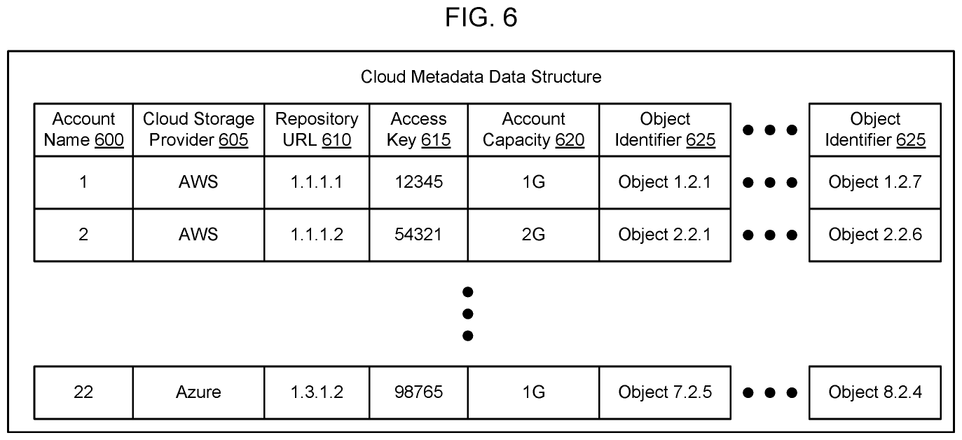

FIG. 6 is a functional block diagram of an example data structure configured to contain example cloud metadata 200, according to some embodiments. As shown in FIG. 6, in some embodiments the metadata backup file 250 of the cloud metadata 200 includes information such as one or more account name 600, one or more cloud storage providers 605, one or more URLs 610 used to access one or more cloud repositories, access information such as an access key 615, and object identifiers 625 identifying the block objects that are stored in the various repositories. Optionally, additional information such as account capacity 620 or other information may be maintained by the cloud block management system 160, which may be included in the cloud metadata depending on the implementation. Other information may be included in the cloud metadata, or less information may be included in the cloud metadata 200, depending on the particular implementation.

In some embodiments, the cloud block management system 160₂ on the second storage system 100₂, is implemented using the same type of software that is used to implement the cloud block management system 160₁ on the first storage system 100₂, to ensure that the second cloud block management system 160₂ is able to ingest the cloud metadata and use the cloud metadata 200 to configure cloud access to the cloud repositories 210.

Exporting a backup copy of the cloud metadata created by a first cloud block management system 160₁ from a first storage system 100₁, and importing the backup copy of the cloud metadata to a second block management system 160₂ on a second storage system 100₂, enables automated movement of application images to the second storage system 100₂. Particularly in instances where replication technologies are not able to be implemented, for example in connection with movement of data between heterogeneous storage arrays, the ability to configure the second storage system to access the objects stored in the cloud repositories enables the application image to be recreated in any storage system where the cloud block management system 160 is able to be installed in a container.

The methods described herein may be implemented as software configured to be executed in control logic such as contained in a CPU (Central Processing Unit) or GPU (Graphics Processing Unit) of an electronic device such as a computer. In particular, the functions described herein may be implemented as sets of program instructions stored on a non-transitory tangible computer readable storage medium. The program instructions may be implemented utilizing programming techniques known to those of ordinary skill in the art. Program instructions may be stored in a computer readable memory within the computer or loaded onto the computer and executed on computer's microprocessor. However, it will be apparent to a skilled artisan that all logic described herein can be embodied using discrete components, integrated circuitry, programmable logic used in conjunction with a programmable logic device such as a FPGA (Field Programmable Gate Array) or microprocessor, or any other device including any combination thereof. Programmable logic can be fixed temporarily or permanently in a tangible non-transitory computer readable medium such as random-access memory, a computer memory, a disk drive, or other storage medium. All such embodiments are intended to fall within the scope of the present invention.

Throughout the entirety of the present disclosure, use of the articles “a” or “an” to modify a noun may be understood to be used for convenience and to include one, or more than one of the modified noun, unless otherwise specifically stated. The term “about” is used to indicate that a value includes the standard level of error for the device or method being employed to determine the value. The use of the term “or” in the claims is used to mean “and/or” unless explicitly indicated to refer to alternatives only or the alternatives are mutually exclusive, although the disclosure supports a definition that refers to only alternatives and to “and/or.” The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of cloud-based recovery of snapshot images between heterogeneous storage arrays, comprising:
generating cloud metadata by a first instance of a cloud block management system on a first storage array, the cloud metadata including information identifying one or more cloud providers, one or more cloud repositories created on the cloud providers, and block objects stored by the first cloud block management system in the cloud repositories;
generating a metadata backup file containing a copy of the cloud metadata;
exporting the metadata backup file containing the copy of the cloud metadata to an external computer;
creating a second instance of the cloud block management system on a second storage array;
importing the metadata backup file containing the copy of the cloud metadata to the second instance of the cloud block management system on a second storage array; and
using the cloud metadata from the metadata backup file to configure the second instance of the cloud block management system on the second storage array to configure the second instance of the cloud block management system to access the one or more cloud providers, access the one or more cloud repositories created on the cloud providers, and to access the block objects stored in the cloud repositories.

2. The method of claim 1, wherein the external computer is a laptop computer, an external management system, or a thumb drive.

3. The method of claim 1, wherein creating the second instance of the cloud block management system on a second storage array.

4. The method of claim 1, wherein the first storage array and second storage array are heterogeneous.

5. The method of claim 4, wherein the first storage array and second storage array are not compatible and not capable of being configured to participate in a remote data forwarding mirroring relationship.

6. The method of claim 1, wherein exporting the metadata backup file containing the copy of the cloud metadata to an external computer is implemented via a first management system executing on the first storage array.

7. The method of claim 6, wherein importing the metadata backup file containing the copy of the cloud metadata to the second storage array is implemented via a second management system executing on the second storage array.

8. The method of claim 1, wherein exporting the metadata backup file comprises encrypting the metadata backup file using a password; and
wherein importing the metadata backup file comprises decrypting the metadata backup file using the password.

9. The method of claim 1, wherein the block objects are snapshot images of an application filesystem.

10. The method of claim 1, wherein the cloud metadata comprises metadata information required to obtain access to one or more cloud accounts, each cloud account having an account name, a cloud storage provider name, a repository URL, an access key, and a set of block object identifiers.

11. A system for enabling cloud-based recovery of snapshot images between heterogeneous storage arrays, comprising:
one or more computers and one or more storage devices storing instructions that are operable, when executed by the one or more computers, to cause the one or more computers to perform operations comprising:
generating cloud metadata by a first instance of a cloud block management system on a first storage array, the cloud metadata including information identifying one or more cloud providers, one or more cloud repositories created on the cloud providers, and block objects stored by the first cloud block management system in the cloud repositories;
generating a metadata backup file containing a copy of the cloud metadata;
exporting the metadata backup file containing the copy of the cloud metadata to an external computer;
creating a second instance of the cloud block management system on a second storage array;
importing the metadata backup file containing the copy of the cloud metadata to the second instance of the cloud block management system on a second storage array; and
using the cloud metadata from the metadata backup file to configure the second instance of the cloud block management system on the second storage array to configure the second instance of the cloud block management system to access the one or more cloud providers, access the one or more cloud repositories created on the cloud providers, and to access the block objects stored in the cloud repositories.

12. The system for enabling cloud-based recovery of snapshot images between heterogeneous storage arrays of claim 11, wherein the external computer is a laptop computer, an external management system, or a thumb drive.

13. The system for enabling cloud-based recovery of snapshot images between heterogeneous storage arrays of claim 11, wherein creating the second instance of the cloud block management system on a second storage array.

14. The system for enabling cloud-based recovery of snapshot images between heterogeneous storage arrays of claim 11, wherein the first storage array and second storage array are heterogeneous.

15. The system for enabling cloud-based recovery of snapshot images between heterogeneous storage arrays of claim 14, wherein the first storage array and second storage array are not compatible and not capable of being configured to participate in a remote data forwarding mirroring relationship.

16. The system for enabling cloud-based recovery of snapshot images between heterogeneous storage arrays of claim 11, wherein exporting the metadata backup file containing the copy of the cloud metadata to an external computer is implemented via a first management system executing on the first storage array.

17. The system for enabling cloud-based recovery of snapshot images between heterogeneous storage arrays of claim 16, wherein importing the metadata backup file containing the copy of the cloud metadata to the second storage array is implemented via a second management system executing on the second storage array.

18. The system for enabling cloud-based recovery of snapshot images between heterogeneous storage arrays of claim 11, wherein exporting the metadata backup file comprises encrypting the metadata backup file using a password; and
wherein importing the metadata backup file comprises decrypting the metadata backup file using the password.

19. The system for enabling cloud-based recovery of snapshot images between heterogeneous storage arrays of claim 11, wherein the block objects are snapshot images of an application filesystem.

20. The system for enabling cloud-based recovery of snapshot images between heterogeneous storage arrays of claim 11, wherein the cloud metadata comprises metadata information required to obtain access to one or more cloud accounts, each cloud account having an account name, a cloud storage provider name, a repository URL, an access key, and a set of block object identifiers.
